(19) United States
(12) Patent Application Publication
(10) Pub. No.: US 2022/0122003 A1
(43) Pub. Date: Apr. 21, 2022

(54) GROUP TICKET RESERVATION SYSTEM AND METHOD

(71) Applicant: Axia Equity Partners, LLC, Rosemont, IL (US)

(72) Inventor: Niko Drakoulis, Arlington Heights, IL (US)

(73) Assignee: Axia Equity Partners, LLC, Rosemont, IL (US)

(21) Appl. No.: 17/072,098

(22) Filed: Oct. 16, 2020

(51) Int. Cl. G06Q 10/02; G06Q 20/08; G06Q 20/04; G06Q 20/32

(52) U.S. Cl. CPC G06Q 10/02; G06Q 20/085; G06Q 40/02; G06Q 20/322; G06Q 20/045

(57) ABSTRACT

A group ticket reservation system includes a first external device, a second external device, a communication device, a processing device, and a memory. The processing device is in electronic communication with the first and the second external devices through the communication device. The memory is in electronic communication with the processing device. The memory comprises programming code for execution by the processing device. The programming code, in conjunction with the processing device, is configured to receive a request for a certain number of group tickets to an event, reserve the certain number of group tickets, receive and/or credit a first payment from a first user through the first external device for a first number of the certain number of group tickets, and receive and/or credit a second payment from a second user through the second external device for a second number of the certain number of group tickets.

### FIELD OF THE DISCLOSURE

This disclosure relates to a group ticket reservation system and method.

### BACKGROUND

The existing systems and methods for reserving group tickets to an event typically require payment upfront for the entire group. This can make it problematic when multiple members of the group wish to pay separately for their tickets. Often, one member of the group pays for all of the group's tickets, and then must spend time contacting each member of the group to collect payment for that member's tickets. This can be time-consuming, awkward, and a huge hassle.

A group ticket system and method are needed to resolve one or more issues of one or more of the existing systems and methods.

### SUMMARY

In one embodiment, a group ticket reservation system is disclosed. The group ticket reservation system includes a first external device, a second external device, a communication device, a processing device, and a memory. The processing device is in electronic communication with the first and the second external devices through the communication device. The memory is in electronic communication with the processing device. The memory comprises programming code for execution by the processing device. The programming code, in conjunction with the processing device, is configured to receive a request for a certain number of group tickets to an event, reserve the certain number of group tickets, receive and/or credit a first payment from a first user through the first external device for a first number, a first amount, or a first percentage of the certain number of group tickets, and receive and/or credit a second payment from a second user through the second external device for a second number, a second amount, or a second percentage of the certain number of group tickets.

In another embodiment, a method is disclosed for reserving group tickets. In one step, a processing device, in electronic communication with a memory comprising programming code for execution by the processing device, receives a request for a certain number of group tickets to an event. In another step, the processing device, as instructed by the programming code, reserves the certain number of group tickets. In an additional step, the processing device, as instructed by the programming code, receives and/or credits a first payment, through a communication device, from a first user through a first external device for a first number, a first amount, or a first percentage of the certain number of group tickets. In yet another step, the processing device, as instructed by the programming code, receives and/or credits a second payment, through the communication device, from a second user through a second external device for a second number, a second amount, or a second percentage of the certain number of group tickets.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 is a high-level hardware block diagram of one embodiment of a group ticket reservation system; and

FIGS. 2A-2C comprise a continuous flowchart illustrating one embodiment of a method for reserving group tickets.

### DETAILED DESCRIPTION

The following detailed description is of the best currently contemplated modes of carrying out the disclosure. The description is not to be taken in a limiting sense, but is made merely for the purpose of illustrating the general principles of the disclosure, since the scope of the disclosure is best defined by the appended claims. It is noted that the Figures are purely for illustrative purposes and are not to scale.

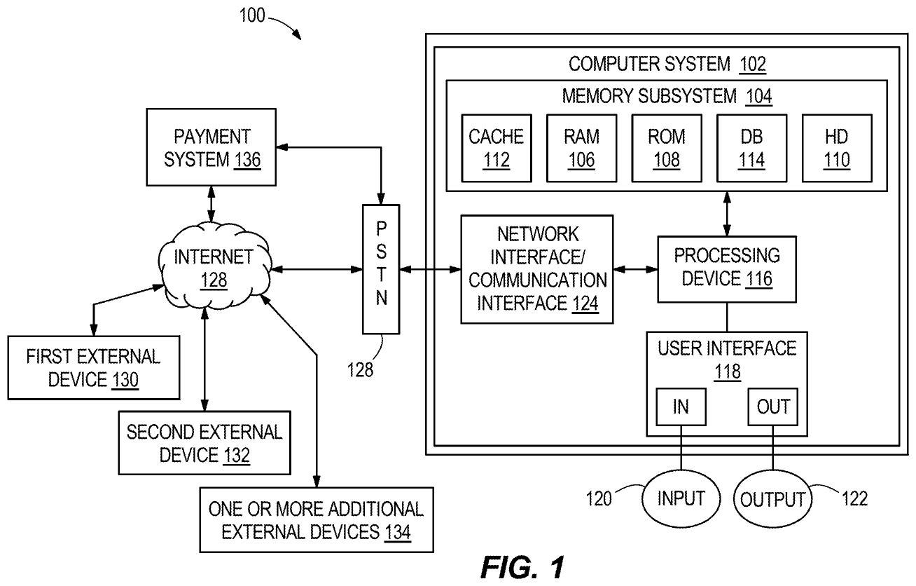

FIG. 1 is a high-level hardware block diagram of one embodiment of a group ticket reservation system 100. The group ticket reservation system 100 may be embodied as a system cooperating with computer hardware components and/or as computer-implemented methods. The group ticket reservation system 100 may include a plurality of software modules or subsystems. The modules or subsystems may be implemented in hardware, software, firmware, or any combination of hardware, software, and firmware, and may or may not reside within a single physical or logical space. For example, the modules or subsystems referred to in this document and which may or may not be shown in the drawings, may be remotely located from each other and may be coupled by a communication network.

The group ticket reservation system 100 may comprise: a computer system 102; a memory subsystem 104; a RAM (random-access memory) 106; a ROM (read-only memory) 108; a HD (hard disk storage) 110; a cache memory 112; a DB (database storage) 114; a processing device 116; a user interface 118; an input 120; an output 122; a communication device (including a network, interface, and/or communication interface) 124; a PSTN (a public switched telephone network) 126; an internet 128; a first external device 130; a second external device 132; optionally one or more additional external devices 134; and a payment system 136.

The computer system 102 that may be used to execute software or logic to implement the trusted query processing. The computer system 102 may be a personal computer and may comprise memory subsystem 104 comprising various hardware components such as RAM 106, ROM 108, hard disk storage 110, cache memory 112, database storage 114, and any other types of needed memory hardware components. The memory subsystem 104 may include any suitable storage components, such as RAM, EPROM (electrically programmable ROM), flash memory, dynamic memory, static memory, FIFO (first-in, first-out) memory, LIFO (last-in, first-out) memory, circular memory, semiconductor memory, bubble memory, buffer memory, disk memory, optical memory, cache memory, and the like. Any suitable form of memory may be used, whether fixed storage on a magnetic medium, storage in a semiconductor device, or remote storage accessible through a communication link.

The computer system 102 may include any suitable processing device 116, such as a computer, microprocessor, RISC processor (reduced instruction set computer), CISC processor (complex instruction set computer), mainframe computer, work station, single-chip computer, distributed processor, server, controller, micro-controller, discrete logic computer, and the like, as is known in the art. For example, the processing device 116 may be an Intel Pentium® microprocessor, x86 compatible microprocessor, or equivalent device, and may be incorporated into a server, a personal computer, or any suitable computing platform. The processing device 116 may execute a software algorithm/processing code stored in the memory subsystem 104 to reserve and pay for a group ticket reservation as described herein.

A user or system interface 118 may be coupled to the computer system 102 and may include various input devices 120, such as switches selectable by the system manager and/or a keyboard. The user interface also may include suitable output devices 122, such as an LCD display, a CRT, various LED indicators, a printer, and/or a speech output device, as is known in the art.

To facilitate communication between the computer system 102 and external sources, a communication device 124 may be operatively coupled to the computer system. The communication device 124 may be, for example, a local area network, such as an Ethernet network, intranet, Internet, or other suitable network. The communication device 124 may also be connected to a public switched telephone network (PSTN) 126 or POTS (plain old telephone system), which may facilitate communication via the internet 128. Any suitable commercially-available communication device or network may be used.

The first external device 130, the second external device 132, and the optional one or more additional external devices 134 may be communication with the computer system 102 through the internet 128 and the PSTN 126. The external devices 130, 132, and 134 may comprise any external device such as another computer system (similar to or identical to computer system 102), a computer processor, a mobile phone, a tablet, a laptop, a desktop, or any other type of external device. The external devices 130, 132, and 134 may contain, comprise, store, or utilize an application, such as a social media application, a ticket application, or other application which one or more users of the external devices 130, 132, and 134 utilize to communicate with the computer system 102 through the internet 128 and the PSTN 126.

The payment system 136 may be communication with the computer system 102 through the internet 128 and the PSTN 126. The payment system 136 may also be in communication with the external devices 130, 132, and 134 through the internet 128 and the PSTN 126. The payment system 136 may comprise a payment processing system for taking payments such as credit card payments, bank payments, or any other type of payments.

The logic, circuitry, and processing described above may be encoded or stored in a machine-readable or computer-readable medium such as a compact disc read only memory (CDROM), magnetic or optical disk, flash memory, random access memory (RAM) or read only memory (ROM), erasable programmable read only memory (EPROM) or other machine-readable medium as, for examples, instructions for execution by a processor, controller, or other processing device.

The medium may be implemented as any device that contains, stores, communicates, propagates, or transports executable instructions for use by or in connection with an instruction executable system, apparatus, or device. Alternatively or additionally, the logic may be implemented as analog or digital logic using hardware, such as one or more integrated circuits, or one or more processors executing instructions; or in software in an application programming interface (API) or in a Dynamic Link Library (DLL), functions available in a shared memory or defined as local or remote procedure calls; or as a combination of hardware and software.

In other implementations, the logic may be represented in a signal or a propagated-signal medium. For example, the instructions that implement the logic of any given program may take the form of an electronic, magnetic, optical, electromagnetic, infrared, or other type of signal. The systems described above may receive such a signal at a communication interface, such as an optical fiber interface, antenna, or other analog or digital signal interface, recover the instructions from the signal, store them in a machine-readable memory, and/or execute them with a processor.

The systems may include additional or different logic and may be implemented in many different ways. A processor may be implemented as a controller, microprocessor, microcontroller, application specific integrated circuit (ASIC), discrete logic, or a combination of other types of circuits or logic. Similarly, memories may be DRAM, SRAM, Flash, or other types of memory. Parameters (e.g., conditions and thresholds) and other data structures may be separately stored and managed, may be incorporated into a single memory or database, or may be logically and physically organized in many different ways. Programs and instructions may be parts of a single program, separate programs, or distributed across several memories and processors.

In other embodiments, the group ticket reservation system 100 of FIG. 1 may vary. One or more of the components of the group ticket reservation system 100 may be varied or eliminated, one or more additional components may be added, or the system 100 may be varied in other ways.

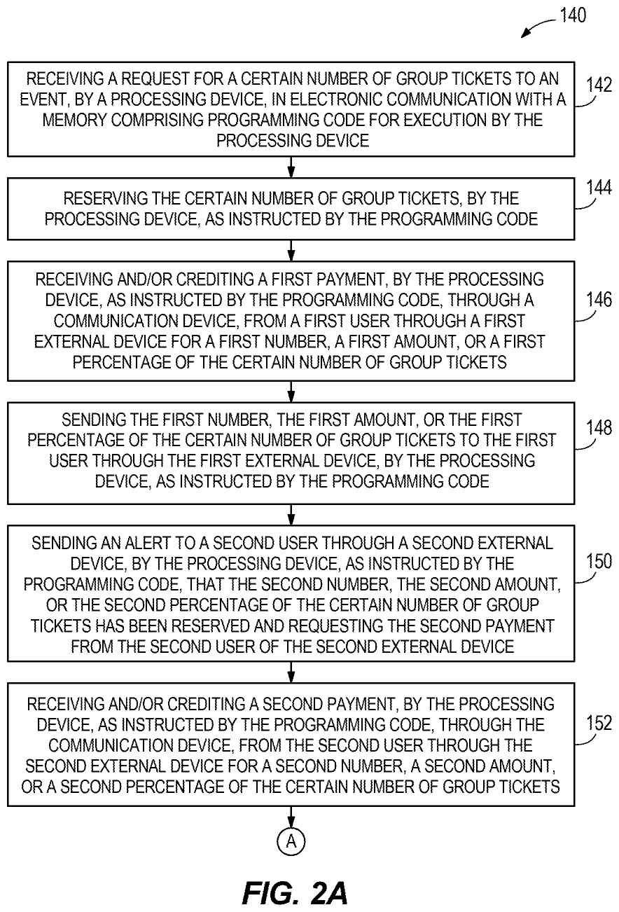

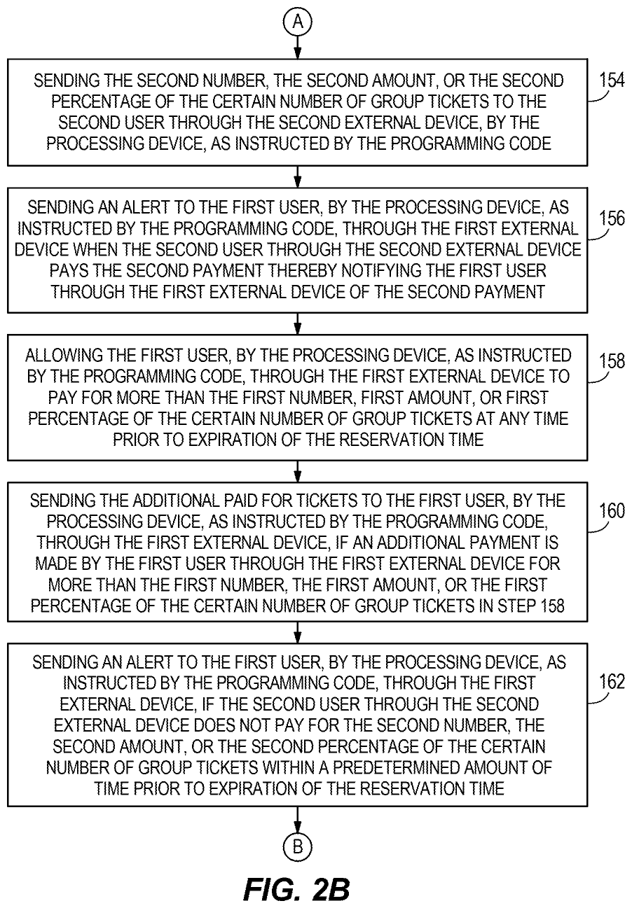

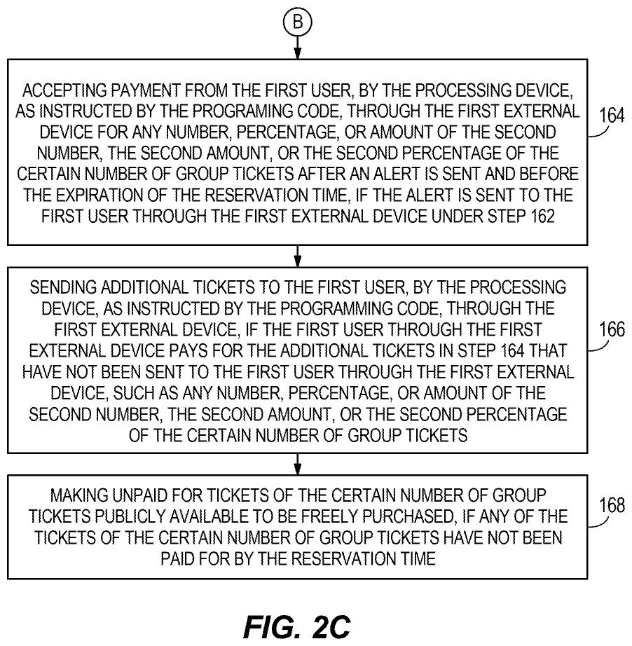

FIGS. 2A-2C comprise a continuous flowchart illustrating one embodiment of a method 140 for reserving group tickets. The method 140 may utilize the group ticket reservation system 100 of FIG. 1. The method 140 may be saved as an algorithm/programming code in the memory subsystem 104, and may be executed by the processing device 116 of the group ticket reservation system 100 of FIG. 1. In other embodiments, the method 140 may utilize varying group ticket reservation systems.

In step 142, a processing device, in electronic communication with a memory comprising programming code for execution by the processing device, may receive a request for a certain number of group tickets to an event. The event may be a sporting event, a concert, a play, a movie, a comedy, or another type of event. In one embodiment, the request for the certain number of group tickets to the event may be received by the processing device from a first user through a first external device. The processing device may communicate with the first external device through a communication device using the internet, radio waves, or other communication means. The first external device may comprise a computer system, a computer processor, a mobile phone, a tablet, a laptop, a desktop, or any other type of external device or system. In another embodiments, the request may be received by the processing device from another user through another external device, or through other systems or devices.

In step 144, the processing device, as instructed by the programming code, may reserve the certain number of group tickets. In one embodiment, the reserved certain number of group tickets may be disposed side-by-side in one or more rows and/or columns. In one embodiment, the certain number of group tickets may be reserved for a set amount of time (i.e. the reservation time) after which any unpaid tickets of the certain number of reserved group tickets may become unreserved and may become freely available to the general public for purchase, or may be automatically charged to the first user through the first external device. In one embodiment, a first number, a first amount, or a first percentage of the certain number of group tickets may be reserved for the first user through the first external device and a second number, a second amount, or a second percentage of the certain number of the certain number of group tickets may be reserved for a second user through a second external device. In one embodiment, the first user of the first external device may specify the quantity allocation and locations of the certain number of group tickets amongst the first user of the first external device and the second user of the second external device, and optionally amongst one or more users of one or more additional external devices. The first user of the first external device may additionally provide contact information, such as a phone-number, an email address, an application username, or other contact information, for each of the users to which the certain number of group tickets are allocated to, and may specify the set amount of time of the reservation.

In step 146, the processing device, as instructed by the programming code, may receive and/or credit a first payment, through a communication device, from a first user through a first external device for a first number, a first amount, or a first percentage of the certain number of group tickets. As previously disclosed, the first external device may comprise a computer system, a computer processor, a mobile phone, a tablet, a laptop, a desktop, or any other type of external device or system. The communication through the communication device may take place over the internet, radio waves, or through other communication means. Step 146 may utilize a payment system.

In step 148, the processing device, as instructed by the programming code, may send the first number, the first amount, or the first percentage of the certain number of group tickets to the first user through the first external device.

In step 150, the processing device, as instructed by the programming code, may send an alert to a second user through a second external device that the second number, the second amount, or the second percentage of the certain number of group tickets has been reserved and requesting the second payment from the second user of the second external device. The alert may comprise a text, an SMS (short message service), an email, an application message (such as on a social media application or other type of application), a phone-call, or another type of alert. The second external device may comprise a computer system, a computer processor, a mobile phone, a tablet, a laptop, a desktop, or any other type of external device or system. The alert may be sent through a communication device over the internet, radio waves, or through other communication means. In one embodiment, the user of the device that reserved the certain number of group tickets, such as the first external device or another device, may have supplied the contact information for the second user of the second external device, to which the alert is sent to, along with an identification/quantity/etc. of the second number, the second amount, or the second percentage of the certain number of group tickets. In another embodiment, the contact information for the second user of the second external device, to which the alert is sent to, may be known by the group ticket reservation system or may be contained within another application access by the group ticket reservation system.

In step 152, the processing device, as instructed by the programming code, may receive and/or credit a second payment, through the communication device, from the second user through the second external device for a second number, a second amount, or a second percentage of the certain number of group tickets. The communication through the communication device may take place over the internet, radio waves, or through other communication means. Step 152 may utilize a payment system.

In step 154, the processing device, as instructed by the programming code, may send the second number, the second amount, or the second percentage of the certain number of group tickets to the second user through the second external device.

In step 156, the processing device, as instructed by the programming code, may send an alert to the first user through the first external device when the second user through the second external device pays the second payment thereby notifying the first user through the first external device of the second payment. The alert may comprise a text, an SMS (short message service), an email, an application message (such as on a social media application or other type of application), a phone-call, or another type of alert.

In step 158, the processing device, as instructed by the programming code, may allow the first user through the first external device to pay for more than the first number, first amount, or first percentage of the certain number of group tickets at any time prior to expiration of the reservation time. Step 158 may utilize a payment system.

In step 160, the processing device, as instructed by the programming code, may, if an additional payment is made by the first user through the first external device for more than the first number, the first amount, or the first percentage of the certain number of group tickets in step 158, send the additional paid for tickets to the first user through the first external device.

In step 162, if the second user through the second external device does not pay for the second number, the second amount, or the second percentage of the certain number of group tickets within a predetermined amount of time prior to expiration of the reservation time, the processing device, as instructed by the programming code, may send an alert to the first user through the first external device. The alert may comprise a text, an SMS (short message service), an email, an application message (such as on a social media application or other type of application), a phone-call, or another type of alert. In one embodiment, the first external device may set the predetermined amount of time.

In step 164, if an alert is sent to the first user through the first external device under step 162, the processing device, as instructed by the programing code, may accept payment from the first user through the first external device for any number, percentage, or amount of the second number, the second amount, or the second percentage of the certain number of group tickets after the alert is sent and before the expiration of the reservation time. Step 164 may utilize a payment system.

In step 166, if the first user through the first external device pays for additional tickets in step 164 that have not been sent to the first user through the first external device, such as any number, percentage, or amount of the second number, the second amount, or the second percentage of the certain number of group tickets, the processing device, as instructed by the programming code, may send the additional tickets to the first user through the first external device.

In step 168, if any of the tickets of the certain number of group tickets have not been paid for by the reservation time, the unpaid for tickets of the certain number of group tickets may become publicly available to be freely purchased. In another embodiment, if any of the tickets of the certain number of group tickets have not been paid for by the reservation time, the unpaid for tickets of the certain number of group tickets may be charged to the first user through the first external device. Step 168 may utilize a payment system.

In one embodiment, the first number, the first amount, or the first percentage and the second number, the second amount, or the second percentage of the certain number of group tickets may add up to the certain number of group tickets. In another embodiment, the first number, the first amount, or the first percentage and the second number, the second amount, or the second percentage of the certain number of group tickets may add up to less than the certain number of group tickets, and there may be one or more additional users through one or more additional external devices which receive one or more alerts, pay for, and receive at least one additional number of the certain number of group tickets following the method.

In other embodiments, one or more steps of the method 140 may not be followed, may be modified in substance or in order, or one or more additional steps may be added.

One or more embodiments of the disclosure may resolve one or more issues of one or more of the existing group ticket reservation systems and methods by allowing members of a group to separately pay for their tickets, and/or may provide one or more additional benefits.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A group ticket reservation system comprising:
a first external device;
a second external device;
a communication device;
a processing device in electronic communication with the first and the second external devices through the communication device; and
a memory in electronic communication with the processing device, wherein the memory comprises programming code for execution by the processing device, and the programming code, in conjunction with the processing device, is configured to receive a request for a certain number of group tickets to an event, reserve the certain number of group tickets, receive and/or credit a first payment from a first user through the first external device for a first number, a first amount, or a first percentage of the certain number of group tickets, and receive and/or credit a second payment from a second user through the second external device for a second number, a second amount, or a second percentage of the certain number of group tickets.

2. The group ticket reservation system of claim 1 wherein the programming code, in conjunction with the processing device, is further configured to receive the request for the certain number of group tickets from the first user through the first external device.

3. The group ticket reservation system of claim 2 wherein the programming code, in conjunction with the processing device, is further configured to send an alert to the second user through the second external device that the second number, the second amount, or the second percentage of the certain number of group tickets has been reserved and requesting the second payment from the second user.

4. The group ticket reservation system of claim 1 wherein the first and second external devices each comprise at least one of a mobile phone, a tablet, a laptop, a desktop, and a computer.

5. The group ticket reservation system of claim 1 wherein the communication device is configured to allow the processing device to be in communication with the first and second external devices over the internet and/or radio waves.

6. The group ticket reservation system of claim 1 wherein the programming code, in conjunction with the processing device, is further configured to reserve the certain number of group tickets for a set amount of time after which any unpaid tickets of the certain number of group tickets become unreserved and are freely available for purchase.

7. The group ticket reservation system of claim 1 wherein the programming code, in conjunction with the processing device, is further configured to send an alert to the first user through the first external device when the second user of the second external device pays the second payment notifying the first user of the first external device of the second payment.

8. The group ticket reservation system of claim 1 wherein the programming code, in conjunction with the processing device, is further configured to send an alert to the first user through the first external device if the second user of the second external device has not paid for the second number, the second amount, or the second percentage of the certain number of group tickets within a predetermined amount of time prior to expiration of the reservation time.

9. The group ticket reservation system of claim 8 wherein the programing code, in conjunction with the processing device, is further configured to accept payment from the first user through the first external device for the second number, the second amount, or the second percentage of the certain number of group tickets after the alert is sent and before the expiration of the reservation time.

10. The group ticket reservation system of claim 8 wherein the programming code, in conjunction with the processing device, is further configured to allow the first user through the first external device to pay for more than the first number, the first amount, or the first percentage of the certain number of group tickets at any time prior to expiration of the reservation time.

11. The group ticket reservation system of claim 1 wherein the programming code, in conjunction with the processing device, is further configured to send the first number, the first amount, or the first percentage of the certain number of group tickets to the first user through the first external device after the first payment, and to send the second number, the second amount, or the second percentage of the certain number of group tickets to the second user through the second external device after the second payment.

12. The group ticket reservation system of claim 1 wherein the first and second number, the first and second amount, or the first and second percentage of the certain number of group tickets add up to the certain number of group tickets.

13. The group ticket reservation system of claim 1 further comprising at least one additional external device of at least one additional user, the processing device in electronic communication with the at least one additional external device through the communication device, wherein the processing code, in conjunction with the processing device, is further configured to receive and/or credit at least one additional payment to the at least one additional user through the at least one additional external device for at least one additional number of the certain number of group tickets.

14. The group ticket reservation system of claim 1 wherein the certain number of group tickets reserved by the programming code, in conjunction with the processing device, are disposed side-by-side in at least one row and/or at least one column.

15. The group ticket reservation system of claim 1 wherein the programming code, in conjunction with the processing device, is further configured to send an alert, comprising a text, an SMS (short message service), an email, an application message, and/or a phone-call, to the first user through the first external device and/or to the second user through the second external device.

16. A method for reserving group tickets comprising:
a processing device, in electronic communication with a memory comprising programming code for execution by the processing device, receiving a request for a certain number of group tickets to an event;
the processing device, as instructed by the programming code, reserving the certain number of group tickets;
the processing device, as instructed by the programming code, receiving and/or crediting a first payment, through a communication device, from a first user through a first external device for a first number, a first amount, or a first percentage of the certain number of group tickets; and
the processing device, as instructed by the programming code, receiving and/or crediting a second payment, through the communication device, from a second user through a second external device for a second number, a second amount, or a second percentage of the certain number of group tickets.

17. The method of claim 16 further comprising the processing device, as instructed by the programming code, receiving the request for the certain number of group tickets from the first user through the first external device.

18. The method of claim 17 further comprising the processing device, as instructed by the programming code, sending an alert to the second user through the second external device that the second number, second amount, or second percentage of the certain number of group tickets has been reserved and requesting the second payment from the second user.

19. The method of claim 16 wherein the first and second external devices each comprise at least one of a mobile phone, a tablet, a laptop, a desktop, and a computer.

20. The method of claim 16 further comprising the processing device, through the communication device, communicating with the first and second users through the respective first and second external devices over the internet and/or radio waves.

21. The method of claim 16 further comprising the processing device, as instructed by the programming code, reserving the certain number of group tickets for a set amount of time after which any unpaid tickets of the certain number of group tickets become unreserved and are freely available for purchase.

22. The method of claim 16 further comprising the processing device, as instructed by the programming code, sending an alert to the first user through the first external device when the second user through the second external device pays the second payment thereby notifying the first user through the first external device of the second payment.

23. The method of claim 16 further comprising the processing device, as instructed by the programming code, sending an alert to the first user through the first external device if the second user through the second external device has not paid for the second number, the second amount, or the second percentage of the certain number of group tickets within a predetermined amount of time prior to expiration of the reservation time.

24. The method of claim 23 further comprising the processing device, as instructed by the programming code, accepting payment from the first user through the first external device for the second number, the second amount, or the second percentage of the certain number of group tickets after the alert is sent and before the expiration of the reservation time.

25. The method of claim 23 further comprising the processing device, as instructed by the programming code, allowing the first user through the first external device to pay for more than the first number, the first amount, or the first percentage of the certain number of group tickets at any time prior to expiration of the reservation time.

26. The method of claim 16 further comprising the processing device, as instructed by the programming code, sending the first number, the first amount, or the first percentage of the certain number of group tickets to the first user through the first external device after the first payment, and sending the second number, the second amount, or the second percentage of the certain number of group tickets to the second user through the second external device after the second payment.

27. The method of claim 16 wherein the first and second number, the first and second amount, or the first and second percentage of the certain number of group tickets add up to the certain number of group tickets.

28. The method of claim 16 further comprising the processing device, as instructed by the programming code, receiving and/or crediting at least one additional payment, through the communication device, to at least one additional user through at least one additional external device for at least one additional number of the certain number of group tickets.

29. The method of claim 16 further comprising the processing device, as instructed by the programming code, reserving the certain number of group tickets to be disposed side-by-side in at least one row and/or at least one column.

30. The method of claim 16 further comprising the processing device, as instructed by the programming code, sending an alert, comprising a text, an SMS (short message service), an email, an application message, and/or a phone-call, to the first and/or second users through the respective first and/or second external devices.
